(19) United States
(12) Patent Application Publication
(10) Pub. No.: US 2013/0255151 A1
(43) Pub. Date: Oct. 3, 2013

(54) Multiple Plants Watering Device

(71) Applicants: Kim THIBODEAUX, BRIDGE CITY, TX (US); Allen Thibodeaux, BRIDGE CITY, TX (US)

(72) Inventors: Kim THIBODEAUX, BRIDGE CITY, TX (US); Allen Thibodeaux, BRIDGE CITY, TX (US)

(21) Appl. No.: 13/586,656

(22) Filed: Aug. 15, 2012

Related U.S. Application Data
(60) Provisional application No. 61/615,987, filed on Mar. 27, 2012.

(51) Int. Cl. A01G 9/02; A01G 25/00

(52) U.S. Cl. 47/66.1; 47/79

(57) ABSTRACT

A multiple plant watering device comprising a watering container, where the watering container is surrounded by a set a sidewalls, and where the watering container is a solid piece of material; and a plurality of planters held within the watering container, where the plurality of planters each house a plant. The planters are removable from the watering container to enable removal and replacement of the plants as desired by the user.

### CROSS REFERENCE TO OTHER APPLICATIONS

This application claims priority to U.S. Provisional Application Ser. No. 61/615,987 filed on Mar. 27, 2012.

### BACKGROUND OF THE INVENTION

1. Field of the Invention

The present invention relates to a plant watering device to hold and contain multiple plants as a means to support and distribute the water to each plant.

2. Description of Related Art

Typically many people utilize individual planters to contain and water each of their plants. Some people use larger planters which may house many plants or even large plants. In many greenhouses or planting stores, the planters are commonly placed on pallets to allow the plants to be transported many all at once. Current methods of watering plants stored on pallets involve moving pallets away from dry areas, watering the plats outside, waiting for the plants to dry, and then returning them back to their dry areas for sale. This process can be extremely time consuming as well as a safety hazard, leaving both water and leaves on the surrounding area.

It would be beneficial in the art to provide a plant watering device that houses many planters all at once. It would also be desirable for the plant watering device to allow watering inside without having to remove the planters outside before applying water.

### SUMMARY OF THE INVENTION

In view of the foregoing disadvantages inherent in the prior art, the general purpose of the present invention is to provide a watering device, configured to include all of the advantages of the prior art, and to overcome the drawbacks inherent therein.

Accordingly, an object of the present invention is to provide a multiple plant watering device that is a solid structure to enable a user to water the contained planters without having to transport them outside.

To achieve the above objects, in an aspect of the present invention, a multiple plant watering device is described comprising a watering container, where the watering container is surrounded by a set a sidewalls, and where the watering container is a solid piece of material; and a plurality of planters held within the watering container, where the plurality of planters each house a plant. The planters are removable from the watering container to enable removal and replacement of the plants as desired by the user.

These together with other aspects of the present invention, along with the various features of novelty that characterize the present invention, are pointed out with particularity in the claims annexed hereto and form a part of this present invention. For a better understanding of the present invention, its operating advantages, and the specific objects attained by its uses, reference should be made to the accompanying drawings and descriptive matter in which there are illustrated exemplary embodiments of the present invention.

### BRIEF DESCRIPTION OF THE DRAWINGS

The advantages and features of the present invention will become better understood with reference to the following detailed description and claims taken in conjunction with the accompanying drawing in which:

FIG. 1 depicts a perspective view of a multiple plant watering device in accordance with an exemplary embodiment of the present invention.

### DETAILED DESCRIPTION OF THE DRAWINGS

The present invention relates to a plant watering device that is comprised of a solid container, with no holes to successfully retain water. The multiple plant watering device is an easy to use device to completely nourish the containing plants. The multiple plant watering device is placed upon a moving pallet, and the solid container prevents water from leaking saving both time and energy spent is moving the planters and waiting for them to dry.

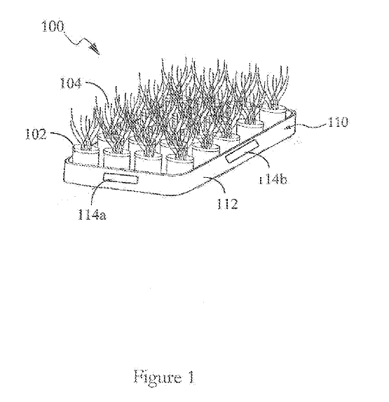

Turning now descriptively to the drawings, referring to FIG. 1, a multiple plant watering device 100 is shown in accordance with an exemplary embodiment of the present invention. The multiple plant watering device 100 includes a watering container 110 to support multiple planters 102. Within each planter 102 is a plant 104, where the type of plant 104 is selected as preferred by the user. The planters 102 are removable to allow the user to remove and replace the planters 102 as necessary. The planters 102 may be arranged in rows and columns of two planters long by two planters wide and up to six by size depending on the needs of the user. Preferably the planters 102 are arranged as 4 long by 5 wide to allow 20 planters 102 to rest within the watering container 110 at once. Finally, the planters 102 may be circular shaped (as shown) or may be rectangular or square shaped, depending on the likes and preferences of the user.

The watering container 110 is surrounded by a set of side walls 112 that assist in containing the planters 102 within the watering container 110. The side walls 112 may be up to 4 inches tall, with curled, rounded edges. The watering container 110 is a solid structure with a smooth, flat, bottom surface to prevent water from leaking out of the bottom or sides. The watering container 110 may be made from plastic, aluminum, wood or similar lightweight waterproof materials. Within the side walls 112 may be a set of handles 114a and 114b to enable a user to easily carry and transport the multiple plant watering device 100. Attached to the underside of the watering container 110 may be a set of feet 116. The feet 116 support the watering container 110 to keep it elevated during use.

The multiple plant watering device 100 features a plastic container thick enough to prevent tearing when supporting multiple planters, yet light enough to be carried by a user. The container is solid to properly container water, and to prevent leaking during transport. The multiple plant watering device is designed to be durable, easy to use, effective, lightweight, and reusable, which will save time, energy, and money to help prolong the life of the contained plants.

The foregoing descriptions of specific embodiments of the present invention have been presented for purposes of illustration and description. They are not intended to be exhaustive or to limit the invention to the precise forms disclosed, and obviously many modifications and variations are possible in light of the above teaching. The exemplary embodiment was chosen and described in order to best explain the principles of the invention and its practical application, to thereby enable others skilled in the art to best utilize the invention and various embodiments with various modifications as are suited to the particular use contemplated.

What is claimed is:

1. A multiple plant watering device comprising:
a watering container, where the watering container is surrounded by a set a sidewalls, and where the watering container is a solid piece of material; and
a plurality of planters held within the watering container, where the plurality of planters each house a plant.

2. The multiple plant watering device according to claim 1, where the sidewalls of the watering container include a set of handles.

3. The multiple plant watering device according to claim 1, where the sidewalls are four inches tall.

4. The multiple plant watering device according to claim 1, where the watering container includes a set of feet.

5. The multiple plant watering device according to claim 1, where the plurality of planters are removable.

6. The multiple plant watering device according to claim 1, where the watering container is made from one of at least plastic, aluminum and wood.

7. The multiple plant watering device according to claim 1, where the watering container rests upon a moving pallet for transport.

8. The multiple plant watering device according to claim 1, where the watering container supports 20 planters arranged as four planters long by five planters wide.
